(19) United States
(12) Patent Application Publication
(10) Pub. No.: US 2010/0221396 A1
(43) Pub. Date: Sep. 2, 2010

(54) Protein crisps and method of manufacturing same

(76) Inventor: Alex Rogers, Brick, NJ (US)

Correspondence Address: CLIFFORD G. FRAYNE, 136 DRUM POINT RD, SUITE 7A, BRICK, NJ, 08723, US

(21) Appl. No.: 12/660,398

(22) Filed: Feb. 25, 2010

Related U.S. Application Data
(60) Provisional application No. 61/208,889, filed on Mar. 2, 2009.

(51) Int. Cl. A23J 1/20; A23P 1/02

(52) U.S. Cl. 426/285; 426/583

(57) ABSTRACT

A whey protein crisp comprised of whey protein isolate, whey protein concentrate, and a binder, dry blended and mixed with water and introduced into an extruder which forms tubular whey protein strips which are cut to size and then dried. The protein crisp may optionally include a flavoring and/or a sweetener.

### RELATED APPLICATIONS

Applicant claims the benefit of provisional application Ser. No. 61/208,889, filed Mar. 2, 2009.

### BACKGROUND OF THE INVENTION

1. Field of the Invention

The present invention relates to protein supplements, and in particular, to a protein crisp formulated of whey protein powder which can be consumed directly or utilized in cooking and food preparation as a supplement.

2. Description of the Prior Art

Whey protein powder is the preferred protein powder for use as a protein supplement. It contains a higher amount of protein and dissolves well in water or other fluids, and does not have a bitter taste. It can be mixed with water, fruit drinks or the like for consumption, however, it does have a draw back from a functionality standpoint in that it cannot be added to food which requires baking or cooking. There therefore has been a need for a form of whey protein powder which can be combined with other forms of food which require baking or cooking which will allow the whey protein powder to imbue its benefits into such foods when baked or cooked.

### OBJECTS OF THE INVENTION

An object of the present invention is to provide for a whey protein crisp similar in size to a grain of rice which can be directly consumed or combined with food stuffs which require baking or cooking, which will allow the whey protein to imbue its benefits into the baked or cooked food.

A further object of the present invention is to provide for a novel whey protein crisp which can be combined easily with other foods as a protein supplement.

A further object of the present invention is to provide for a novel whey protein crisp which can be flavored and eaten directly as a protein supplement.

A still further object of the present invention is to provide for a novel whey protein crisp which is unflavored which can be combined with other foods without affecting the taste of those foods.

A still further object of the present invention is to provide for a novel whey protein crisp which maintains its crispiness at normal temperatures but softens when heated.

A still further object of the present invention is to provide for a novel whey protein crisp which provides a satiety affect to the consumer, which may contribute to weight lost.

### SUMMARY OF THE INVENTION

A whey protein crisp comprised of whey protein isolate, whey protein concentrate, and a binder, dry blended and mixed with water and introduced into an extruder which forms tubular whey protein strips which are cut to size and then dried. The protein crisp may optionally include a flavoring and/or a sweetener.

### BRIEF DESCRIPTION OF THE DRAWINGS

FIG. 1 is a schematic diagram of the method of manufacture.

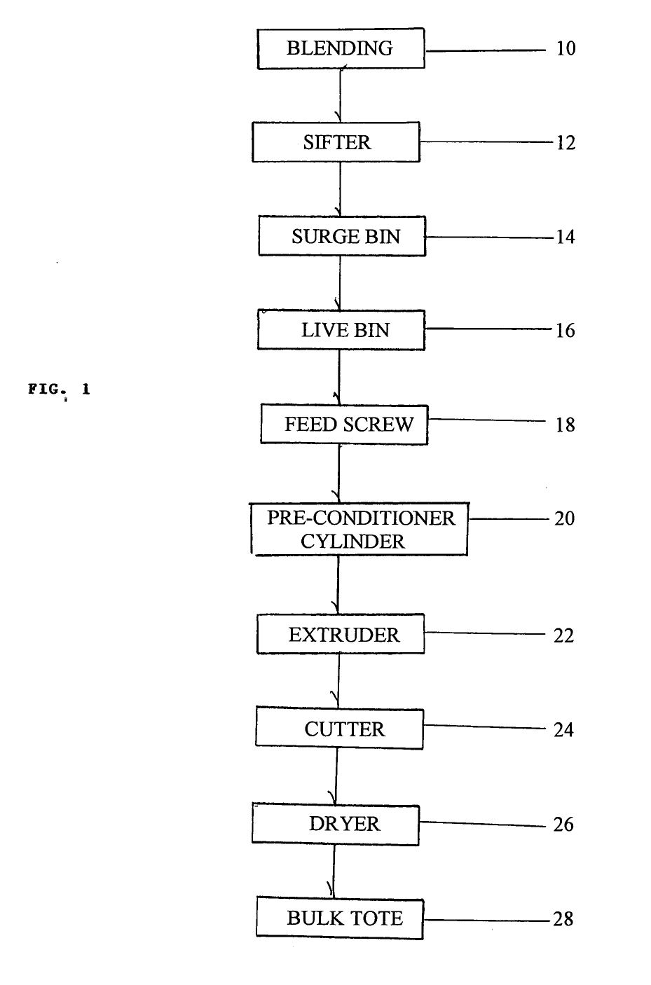

### DETAILED DESCRIPTION OF THE INVENTION

In its basic form, the whey protein crisp of the present invention is prepared from a blend of whey protein isolate, whey protein concentrate, and a binder. The whey crisp of this formulation would have a rather bland taste, if not tasteless, making it ideal for combining it with other foods for cooking and baking such that the protein crisp would not introduce any of its own taste or flavoring to the cooked or baked food, but rather, would allow the cooked or baked food to emanate its natural aroma and taste. One such suitable binder for utilization and formulating the protein crisp would be a starch such as tapioca powder.

Further, since whey protein itself is the preferred source of energy and protein, the whey protein crisp could also be formulated with flavorings and/or sweeteners. Such flavorings could include any and all flavorings utilized in other food stuffs, such as vanilla, chocolate, and the like, and the sweetener in the preferred embodiment would be stevia. In this formulation with the flavorings and sweeteners, the whey protein crisp could be consumed directly as an energy or protein boost in the manner in which protein bars are consumed. The whey protein crisp has the advantage in that it is formulated in the size of grains of rice, which lend themselves to multiple packaging alternatives. For example, the whey protein crisp containing flavoring and/or sweetener could be carried in a small zip lock bag in one's pocket for consumption when a quick protein or energy boost is desired.

The whey protein crisp formulation for use as a food additive without flavoring or sweeteners would have the whey isolate and whey concentrate present at 90 wt % with the starch or binder present at 10 wt %. When flavoring or sweeteners are utilized for the preparation of a whey protein crisp for direct consumption, the flavorings or sweeteners are present in an amount less than five weight percent, and the amount of whey isolate and whey concentrate and the amount of binder or starch would each be slightly reduced, yet maintain their same ratio.

The formulation and manufacture of the whey protein crisp commences with dry ingredients. For the unflavored whey protein crisp, the ingredients would include the whey protein isolate, whey protein concentrate, and a starch binder in the preferred form of tapioca. In the flavored or sweetened form of the whey protein crisp, the additional flavoring and/or sweetener would be added.

These dry ingredients are introduced into a blender 10 and blended into a uniform dry mixture based on blender samples. The dry blend is then discharged from the blender 10 into a sifter 12 and then to a surge bin 14 and thence to an air locked live bin 16 where the dry mixture is then introduced by means of a feed screw 18 into a preconditioner cylinder 20 where the blended dry mixture is then mixed with water in order to obtain the correct dough-like consistency and viscosity for introduction into an extruder 22, the extruder 22 extruding one or more tubular extrusions of the blended powders in combination with the water mixture, the tubular extrusions being subjected to a cutting station 24 which cuts the tubular extrusions into rice-size particles or grains which are then conveyed to a drying station 26 where the rice-size whey protein crisps are dried, preferably at a temperature between 90° F. and 100° F., after which they are transported to a packaging station 28.

The whey protein crisps can be packaged and sold in a variety of different sized containers for personal consumption. As a protein or energy boost, the whey protein crisps can be packaged in smaller containers for facile transport in the pocket, backpack or the like. As a protein additive for food preparation, the whey protein crisps may be sold in larger multi-pound containers.

Therefore, while the present invention has been disclosed with respect to the preferred embodiments thereof, it will be recognized by those of ordinary skill in the art that various changes and modifications can be made without departing from the spirit and scope of the invention. It is therefore manifestly intended that the invention be limited only by the claims and the equivalence thereof.

I claim:

1. A process for making a protein supplement for direct consumption or utilization in cooking and food preparation comprising the steps:
(a) blending a mixture of dry powdered whey isolate, and whey concentrate and a binder wherein said whey isolate and said whey concentrate are present in combination at 90 weight percent and said binder is present at 10 weight percent;
(b) introducing said mixture of step (a) into a preconditioned cylinder, wherein said mixture is mixed with water to obtain a viscous dough-like consistency;
(c) introducing said mixture or step (b) from said preconditioned cylinder into an extruder and extruding one or more tubular extrusions of dough-like consistency;
(d) introducing said tubular extrusions into a cutting station wherein said tubular extrusions are reduced to grain sized particles equivalent to a grain of rice; and
(e) introducing said grain sized particles into a drying station.

2. The process in accordance with claim 1 wherein said binder is a starch.

3. The process in accordance with claim 2 wherein said starch is tapioca.

4. The process in accordance with claim 1 wherein a flavoring or a sweetener in an amount less than 5 weight percent is introduced into the dry blend of step (a).

5. The process in accordance with claim 1 wherein said rice sized grains are dried at a temperature of between 90 degrees Fahrenheit and 100 degrees Fahrenheit.

6. A protein supplement comprising a dry mixture of whey isolate and whey concentrate and a binder wetted with water in which the whey isolate and whey concentrate are present in an amount of 90 weight percent in combination and said binder is present in an amount of ten weight percent, the supplement being tubularly extruded and cut into rice grain size particles and dried.

7. The protein supplement in accordance with claim 6 wherein said protein supplement contains a flavoring and said protein supplement is consumed directly.

8. The protein supplement in accordance with claim 6 wherein said rice grain size particles are incorporated into prepared foods enhancing the available protein therein.

9. The protein supplement in accordance with claim 6 wherein said binder is a starch.

10. The protein supplement in accordance with claim 9 wherein said starch is tapioca.
